(19) United States
(12) Patent Application Publication
(10) Pub. No.: US 2026/0169492 A1
(43) Pub. Date: Jun. 18, 2026

(54) METHODS AND CONTROL SYSTEMS FOR GENERATING AN OPTIMIZED PATH BETWEEN A STARTING POINT AND A TARGET POINT IN A PREDEFINED AREA

(71) Applicant: Greenworks (Jiangsu) Co., Ltd, Changzhou (CN)

(72) Inventor: Andre Lundkvist, Habo (SE)

(21) Appl. No.: 19/537,629

(22) Filed: Feb. 12, 2026

Related U.S. Application Data
(63) Continuation of application No. PCT/CN2023/124871, filed on Oct. 17, 2023.

(51) Int. Cl. G05D 1/644; A01D 34/00; A01D 101/00; G05D 105/15; G05D 107/20; G05D 109/10

(52) U.S. Cl. CPC G05D 1/644; A01D 34/008; A01D 2101/00; G05D 2105/15; G05D 2107/23; G05D 2109/10

(57) ABSTRACT

A method performed by a control system (800) for generating an optimized path (230) between a starting point (101) and a target point (102) in a predefined area (100), the method comprises a tree generating phase using a RRT algorithm, following a tree optimizing phase. An optimized path (230) is generated by performing the method based on a tree (130) developed by the RRT algorithm. The optimized path (230) is shorter and smoother than an original path (240) which is directly obtained from the tree (130). Therefore, a lawn mower can move to its destination 102 more efficiently by moving along the optimized path (230).

### CROSS REFERENCE TO RELATED APPLICATIONS

The present application is a Continuation application of PCT Application No. PCT/CN2023/124871 filed on Oct. 17, 2023, the contents of which are incorporated herein by reference in their entirety.

### TECHNICAL FIELD

The present disclosure relates generally to methods and control systems for generating an optimized path between a starting point and a target point in a predefined area. The present disclosure also relates to computer program and data carrier which relate to the methods and controls systems for generating the optimized path.

### BACKGROUND

When a lawn mower is moving, there is a scenario that the lawn mower needs to move from one position to another position as quick as possible, i.e., looking for an optimal path from a starting point to a target point. When there is no obstacle between the starting point and the target point, it would be easy for the lawn mower to move straight forward to the target point. However, when there is at least one obstacle between the starting point and the target point and the lawn mower cannot move through the obstacle, a path needs to be calculated for the lawn mower, so that the lawn mower can move to the target point as quick as possible without meeting with the obstacle.

Rapidly-exploring random tree (RRT) algorithm is developed for solving the problem above, i.e., efficiently calculate a tree between the starting point and the target point. A path between the starting point and the target point can be obtained from the tree. The RRT algorithm is illustrated in FIG. 1.

Referring to FIG. 1, the lawn mower needs to move from the starting point 101 to the target point 102 in a predefined area 100. There is an obstacle 103 in the predefined area 100, so that the lawn mower cannot move straight forward from the starting point 101 to the target point 102. Therefore, an RRT algorithm is performed to develop a tree 130 between the starting point to the target point 102. First, the starting point 101 is defined as a root node of the tree 130. Then a random point 104 is defined in the predefined area 100. The random point 104 is different from the starting point 101 and the target point 102. Among all the nodes of the tree 130, a nearest point to the random point 104 is defined. In this situation, since there is only one node 101 in the tree 130, of course node 101 is the nearest point to the random point 104. Then the RRT algorithm determines if a straight line can be drawn between the random point 104 and the nearest point 101 without going through the obstacle 103. In this situation, a straight line can be drawn between 101 and 104, therefore the random point 104 is added to the tree 130, and of course the straight line between the random point 104 and 101 is also added to the tree 130. So, the tree 130 comprises two nodes 101 and 104 now.

Further, after the random point 104 is added to the tree 130, the algorithm determines if a straight line can be drawn between the random point 104 and the target point 102. Obviously, a straight line cannot be drawn between 104 and 102, so the method repeats the step of defining a random point. A random point 105 is defined at this time. Similarly, among all the nodes in the tree 130, the nearest point to the random point 105 is 104. It is determined that a straight line between 104 and 105 can be drawn, so the random point 105 and the straight line between 104 and 105 is also added to the tree 130. Since a straight line cannot be drawn between the random point 105 to the target point 102, the algorithm again repeats the step of defining a random point. The new random point is 107. The algorithm repeats the steps of determining a random point, defining a nearest point and trying to draw a straight line between the random point and the nearest point.

Another situation in the algorithm is that it is determined that a straight line cannot be drawn between a random point and a nearest point in the tree 130. For example, the random point is 120 and the current tree 130 comprises nodes 101, 104, 105, 107, 106, 108, 110, 111, 109. Among all the nodes in the tree 130, the nearest point to the random point 120 is 109. However, a straight line cannot be drawn between 109 and 120 due to the obstacle 103. Therefore, the random point 120 is not added to the tree 130 and a new random point will be defined so as to continue the algorithm.

As the algorithm performs, the tree 130 develops and at last a straight line can be drawn between a random point 112 and the target point 102. So, the algorithm terminates and the tree 130 is fully developed. The tree 130 comprises points 101, 104, 105, 107, 106, 108, 110, 111, 109, 112, 102 and lines between these points. The tree 130 connects the starting point 101 and the target point 102 with several branches. A path 101, 104, 107, 108, 110, 111, 112, 102 is generated from the tree 130 and the path leads the lawn mower to move from the starting point 101 to the target point 102 without meeting with the obstacle 103.

However, RRT is a traditional algorithm, and its performance needs to be further improved, i.e., an optimized path needs to be obtained based on the path generated by the RRT algorithm. For example, the path generated by RRT algorithm may comprise too many intermediate nodes and the path is too long and tortuous.

Therefore, there is a need for a solution to optimize the path generated by the RRT algorithm, so that the optimized path is shorter and smoother, leading the lawn mower to move efficiently from the starting point to the target point.

### SUMMARY

It is an object of the invention to address at least some of the problems and issues outlined above. It is an object of embodiments of the invention to provide a method for generating an optimized path based on the RRT algorithm, so that a short and smooth path between the starting point and the target point is generated. It is possible to achieve the object and possibly others by providing the methods and control systems as defined in the attached claims.

In a first aspect of the invention, a method performed by a control system for generating an optimized path between a starting point and a target point in a predefined area is disclosed. The predefined area comprises at least one obstacle blocking a straight path between the starting point and the target point comprising the starting point and at least one random point there in between, wherein the method further comprises a tree optimizing phase comprising: a. obtaining an original path from the generated tree, wherein the original path is the shortest path in the tree from the starting point to the target point and with intermediate points there in between; b. defining a first point and an end point of the original path, wherein the first point is the starting point and the end point is the target point or the first point is the target point and the end point is the starting point; c. determining the first point of the original path as a first optimized point of the optimized path and defining an optimizing direction starting from the first optimized point to the end point; d. defining the first optimized point as a current point in the optimized path; e. using the next intermediate point in the optimizing direction of the original path, starting from the current point, as a test point; f. determining if a straight line can be drawn between the current point and the test point; and g. if it is determined in the step f that a straight line can be drawn between the current point and the test point, using the next intermediate point from the test point in the optimizing direction of the original path as an updated test point and return to step f; h, or if it is determined in the step f that a straight line cannot be drawn between the current point and test point, adding the previous test point, as an optimized point, to the optimized path, and defining the previous test point as the current point; i. determining if a straight line can be drawn between the added optimized point and the end point; j. if it is determined in the step i that a straight line can be drawn between the added optimized point and the end point, adding the end point to the optimized path, the method is finished and the optimized path is generated; k. if it is determined in the step i that a straight line cannot be drawn between the added optimized point and the end point, return to step e.

According to another embodiment, the RRT-algorithm uses a max extension policy, i.e., setting a predetermined threshold for the maximum distance between a tree node and a random point in the generated tree; if the distance between the tree node and the random point is greater than this predetermined threshold, disregarding the random point and defining a new random point, wherein the distance from the tree node to the new random point is the predetermined threshold and the new random point is located on a straight line having the same direction as the straight line between the tree node and the disregarded random point.

According to another embodiment, the method further comprises: l. defining a current point in the optimized path, the current point being different from the first point and the end point; m. defining a random direction and a random distance; n. moving the current point in the random direction for the random distance to obtain an updated current point in an updated optimized path, if the total length of the updated optimized path is shorter than the optimized path, and straight lines can be drawn between the updated current point and its preceding and following point in the optimized path.

According to another embodiment, the method further comprises: o. defining a current point in the optimized path, the current point being different from the first point and the end point; p. defining a forward offset point of the current point by moving the current point a predetermined distance towards the preceding point in the optimized path; q. defining a backward offset point of the current point by moving the current point the predetermined distance towards the following point in the optimized path; r. if a straight line can be drawn between the forward offset point and the backward offset point, increasing the predetermined distance and go to the step p; s. if a straight line cannot be drawn between the forward offset point and the backward offset point, replacing the current point with previous forward offset point and previous backward offset point in the optimized path.

In a second aspect of the invention, a control system for generating an optimized path between a starting point and a target point in a predefined area is disclosed. The predefined area comprises at least one obstacle blocking a straight path between the starting point and the target point, the control system is operative for performing a method comprising a tree generating phase using a Rapidly-exploring Random Tree, RRT, algorithm, resulting in a tree comprising the starting point, the target point and at least one random point there in between, the control system comprises a processing circuitry and a memory, the memory containing instructions executable by the processing circuitry, whereby the control system is further operative for performing the method comprising a tree optimizing phase following the tree generating phase, the tree optimizing phase comprises: a. obtaining an original path from the generated tree, wherein the original path is the shortest path in the tree from the starting point to the target point and with intermediate points there in between; b. defining a first point and an end point of the original path, wherein the first point is the starting point and the end point is the target point or the first point is the target point and the end point is the starting point; c. determining the first point of the original path as a first optimized point of the optimized path and defining an optimizing direction starting from the first optimized point to the end point; d. defining the first optimized point as a current point in the optimized path; e. using the next intermediate point in the optimizing direction of the original path, starting from the current point, as a test point; f. determining if a straight line can be drawn between the current point and the test point; and g. if it is determined in the step f that a straight line can be drawn between the current point and the test point, using the next intermediate point from the test point in the optimizing direction of the original path as an updated test point and return to step f; or h. if it is determined in the step f that a straight line cannot be drawn between the current point and test point, adding the previous test point, as an optimized point, to the optimized path, and defining the previous test point as the current point; i. determining if a straight line can be drawn between the added optimized point and the end point; j. if it is determined in the step i that a straight line can be drawn between the added optimized point and the end point, adding the end point to the optimized path, the method is finished and the optimized path is generated; k. if it is determined in the step i that a straight line cannot be drawn between the added optimized point and the end point, return to step e.

In other embodiments, the control system a is further operative for performing the methods defined above.

In a third aspect of the invention, a lawn mower comprising the control system is disclosed, wherein the lawn mower is operative for moving along the optimized path generated by the control system.

According to another embodiment, the lawn mower is operative for moving along a curve when turning.

In a fourth aspect of the invention, a computer program is disclosed, the computer program comprising instructions, which, when executed by a processing circuitry of a control system, causes the control system to generate an optimized path, according to the methods defined above.

In a fifth aspect of the invention, a carrier containing the computer program is disclosed, wherein the carrier is one of an electronic signal, an optical signal, a radio signal, an electric signal, or a computer readable storage medium.

### BRIEF DESCRIPTION OF DRAWINGS

The invention is now described, by way of example, with reference to the accompanying drawings, in which:

FIG. 1 schematically shows a predefined area for RRT algorithm.

FIG. 2 schematically shows a predefined area for optimizing the RRT algorithm, according to possible embodiments.

FIG. 3 schematically shows a flow chart of the method for generating the optimized path, according to possible embodiments.

FIG. 4 schematically shows a maxi extension policy of the RRT algorithm.

FIG. 5 schematically shows a method for further optimizing the optimized path, according to possible embodiments.

FIG. 6 schematically shows a method for further optimizing the optimized path, according to possible embodiments.

FIGS. 7a and 7b show results of the optimizing methods, according to possible embodiments.

FIG. 8 schematically shows the control system in detail, according to possible embodiments.

FIG. 9 schematically shows the lawn mower and the control system.

### DETAILED DESCRIPTION

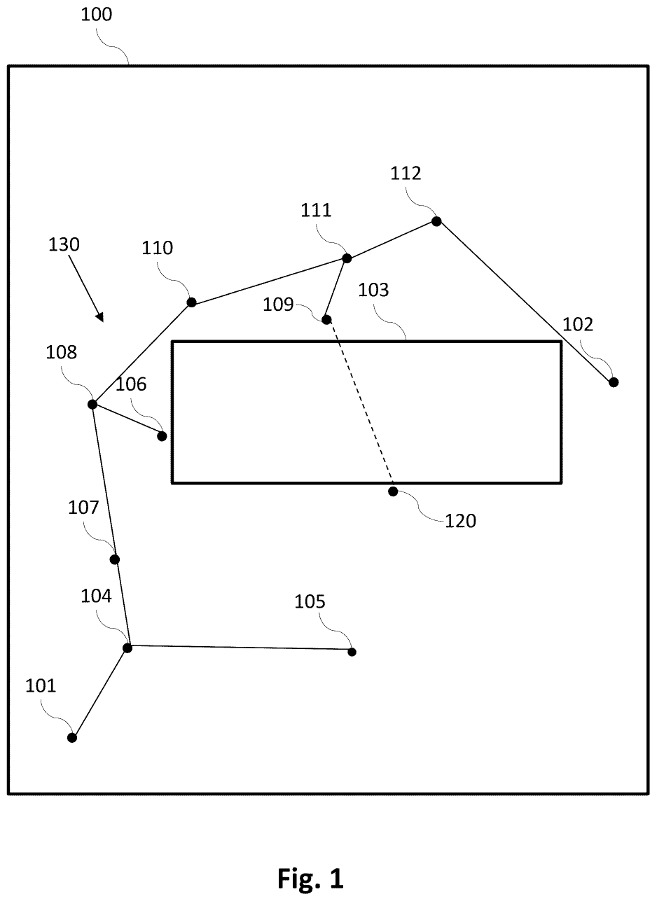

As explained in the Background, FIG. 1 shows the RRT algorithm and a tree 130 that is developed after the RRT algorithm is performed. The tree 130 comprises the points 101, 104, 105, 107, 108, 106, 110, 111, 109, 112 and 102.

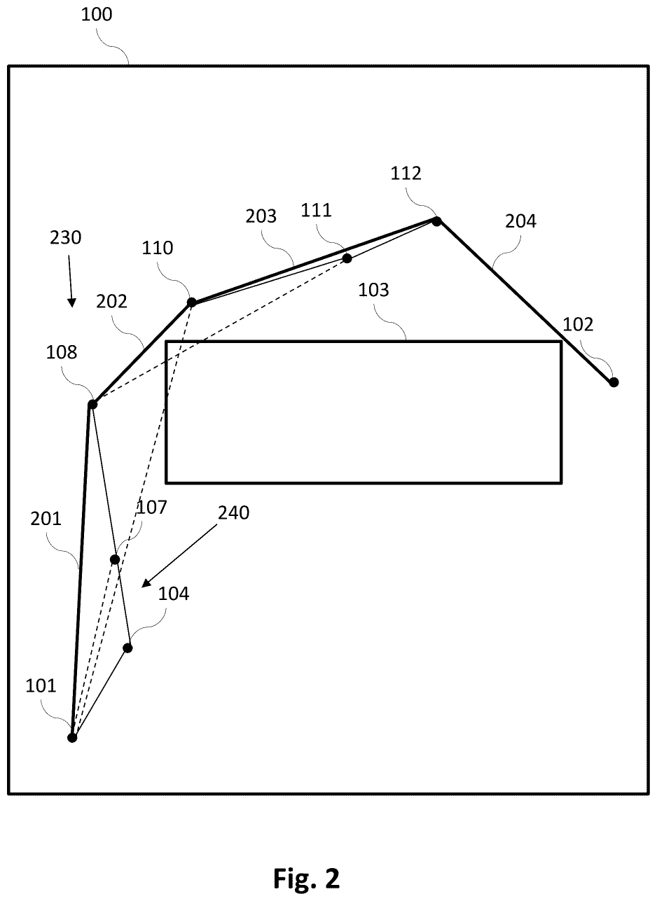

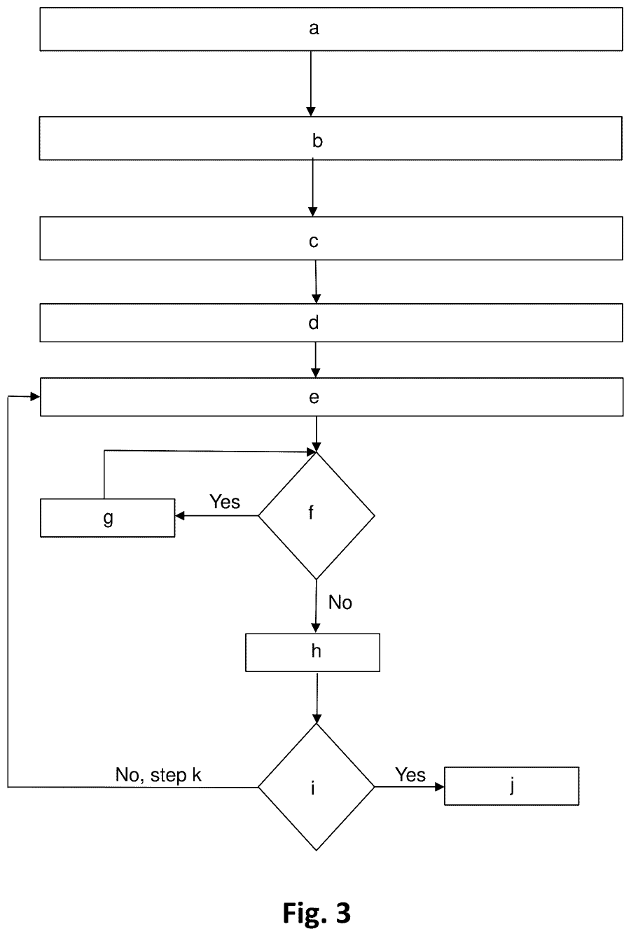

Referring to FIGS. 2 and 3, a method performed by a control system 800 is disclosed. The method is used for generating an optimized path 230 between a starting point 101 and a target point 102 in a predefined area 100. The predefined area 100 comprises at least one obstacle 103 blocking a straight path between the starting point 101 and the target point 102. The method comprises a tree generating phase using a Rapidly-exploring Random Tree, RRT, algorithm, resulting in a tree 130 comprising the starting point 101, the target point 102 and at least one random point 104, 105, 106, 107, 108, 109, 110, 111, 112 there in between. The method further comprises a tree optimizing phase comprises: a. obtaining an original path 240 from the generated tree 130, wherein the original path 240 is the shortest path in the tree 130 from the starting point 101 to the target point 102 and with intermediate points 104, 107, 108, 110, 111, 112 there in between; b. defining a first point and an end point of the original path 240, wherein the first point is the starting point 101 and the end point is the target point 102 or the first point is the target point 102 and the end point is the starting point 101; c. determining the first point of the original path 240 as a first optimized point of the optimized path 230 and defining an optimizing direction starting from the first optimized point to the end point; d. defining the first optimized point as a current point in the optimized path 230; e. using the next intermediate point 104, 107, 108, 110, 111, 112 in the optimizing direction of the original path 240, starting from the current point, as a test point; f. determining if a straight line can be drawn between the current point and the test point; and g. if it is determined in the step f that a straight line can be drawn between the current point and the test point, using the next intermediate point 104, 107, 108, 110, 111, 112 from the test point in the optimizing direction of the original path 240 as an updated test point and return to step f; or h. if it is determined in the step g that a straight line cannot be drawn between the current point and test point, adding the previous test point, as an optimized point, to the optimized path 230, and defining the previous test point as the current point; i. determining if a straight line can be drawn between the added optimized point and the end point; j. if it is determined in the step i that a straight line can be drawn between the added optimized point and the end point, adding the end point to the optimized path 230, the method is finished and the optimized path 230 is generated; k. if it is determined in the step i that a straight line cannot be drawn between the added optimized point and the end point, return to step e.

In this method, as discussed in paragraphs related to FIG. 1, a tree 130 is generated using the RTT algorithm in a tree generating phase. Following the tree generating phase, a tree optimizing phase is included in the method. Since the tree 130 may comprise branches, in the beginning of the tree optimizing phase, an original path needs to be obtained from the tree 130. Therefore, in step a, an original path 240 is obtained from the tree 130, the original path 240 is the shortest path in the tree 130 so that the starting point 101 and the target point 102 are connected. The term “original” indicates that this path 240 needs to be optimized further.

Some concepts need to be defined for the optimization. In step b, a first point and an end point of the original path 240 are defined. The first point can be the starting point 101, so that the end point is the target point 102 accordingly. Alternatively, the first point can be the target point 102, so that the end point is the starting point 101 accordingly.

In step c, the first point of the original path 240 is defined as the first optimized point of an optimized path 230. An optimizing direction is defined as the direction starting from the first optimized point (which is also the first point of the original path 240) to the end point.

By definitions in the steps b and c, an optimizing direction is defined. The optimizing direction can be either from 101 to 102, or from 102 to 101. When the optimizing direction is from 101 to 102, the first optimized point in the optimized path 230 is 101. When the optimizing direction is from 102 to 101, the first optimized point in the optimized path 230 is 102. In the explanations below, the optimizing direction from 101 to 102 will be used as an example.

In the step d, the first optimized point 101 in the optimized path 230 is defined as a current point.

In the step e, a next intermediate point of the current point 101 is defined as a test point. In the optimizing direction of the original path 240, the next intermediate point of the current point 101 is 104. Therefore, the point 104 is defined as a test point in this step.

In the step f, the method determines if a straight line can be drawn between the current point 101 and the test point 104.

If the determination in the step f is yes, the method proceeds to step g, the next intermediate point from the test point 104 in the original path 240 becomes an updated test point. In this situation, the next intermediate point 107 becomes the updated test point. The current point is still the point 101. Then the method returns to the step f. In the step f, the method continues to determine if a straight line can be drawn between the current point 101 and the test point 107. Since the result of the determination is still yes, the step g is performed again, that is, the next intermediate point 108 in the original path 240 is defined as the test point. The loop continues to define the next intermediate point 110 as the test point and goes to the step f again.

In the step f, the method determines if a straight line can be drawn between the current point 101 and the test point 110. This time, the result of the determination is no, so the method proceeds to the step h.

In the step h, the previous test point 108 is added to the optimized path 230 as an optimized point, and the previous test point 108 is defined as the current point. After performing this step, the optimized path 230 comprises optimized points 101, 108, and 108 is the current point.

The method proceeds to the step i. In this step, it is determined if a straight line can be drawn between the added optimized point 108 and the end point 102 of the original path 240. This step is used to check if the tree optimizing phase is finished.

In the step k, since a straight line cannot be drawn between the added optimized point 108 and the end point 102, the tree optimizing phase is not finished yet, the method returns to the step e.

In the step e, starting from the current point 108, using the next intermediate point 110 as the test point. It is determined in the step f that a straight line can be drawn between the current point 108 and the test point 110, so the next intermediate point 111 is defined to be the test point in the step g. The method returns to step f again. It is determined in the step f that a straight line cannot be drawn between the current point 108 and the test point 111, so that the previous test point 110 is added to the optimized path 230 as an optimized point, and the previous test point 110 becomes the current point in the step h.

After the above steps, the optimized path 230 comprises the points 101, 108 and 110, and the current point is 110.

In the step i, the method determines if a straight line can be drawn between the added optimized point 110 and the end point 102. Since a straight line cannot be drawn between 110 and 102, the method goes to step k then to step e again.

Similar procedure continues, until point 112 is added to the optimized path 240 as an optimize point. In the step i, the method determines if a straight line can be drawn between the added optimized point 112 and the end point 102. Since a straight line can be drawn between 112 and 102, the method proceeds to the step j, adding the end point 102 to the optimized path 230 and the method is finished. An optimized path 230 is generated. The optimized path 230 includes the optimized points 101, 108, 110, 112, 102 and the lines 201, 202, 203, 204 between the optimized points.

By this method, an optimized path 230 is generated from the original path 240. Obviously, the optimized path 230 comprises less points than the original path 240 and the optimized path 230 is smoother than the original path 240, i.e., not having so many turns as the original path 240. Therefore, it would be more efficient for a lawn mower to move from the starting point 101 to the target point 102 along the optimized path 230 than along the original path 240.

In the other optimizing direction, that is from 102 to 101, the same tree optimizing phase can be performed. In the beginning, the current point is 102 and the test point is 112, then 111. Since no straight line can be drawn between 102 and 111, previous test point 112 is added to the optimized path as an optimized point and the 112 becomes the current point. Starting from the current point 112, test points 111, 110 and 108 are defined. When it comes to the test point 108, no straight line can be drawn between the current point 112 and the test point 108, so the previous test point 110 is added to the optimized path as an optimized point and the previous test point 110 becomes the current point. Similarly, test point 108 is added to the optimized path as an optimized point. Since a straight line can be drawn between the added optimized point 108 and the end point 101, the method is finished. The optimized path 230 comprises points 102, 112, 110, 108, 101 and the lines 204, 203, 202, 201.

According to another embodiment, the RRT-algorithm uses a max extension policy, i.e., setting a predetermined threshold for the maximum distance between a tree node 110 and a random point 120 in the generated tree 130; if the distance between the tree node 110 and the random point 120 is greater than this predetermined threshold, disregarding the random point 120 and defining a new random point 122, wherein the distance from the tree node 110 to the new random point 122 is the predetermined threshold and the new random point 122 is located on a straight line having the same direction as the straight line between the tree node 110 and the disregarded random point 120.

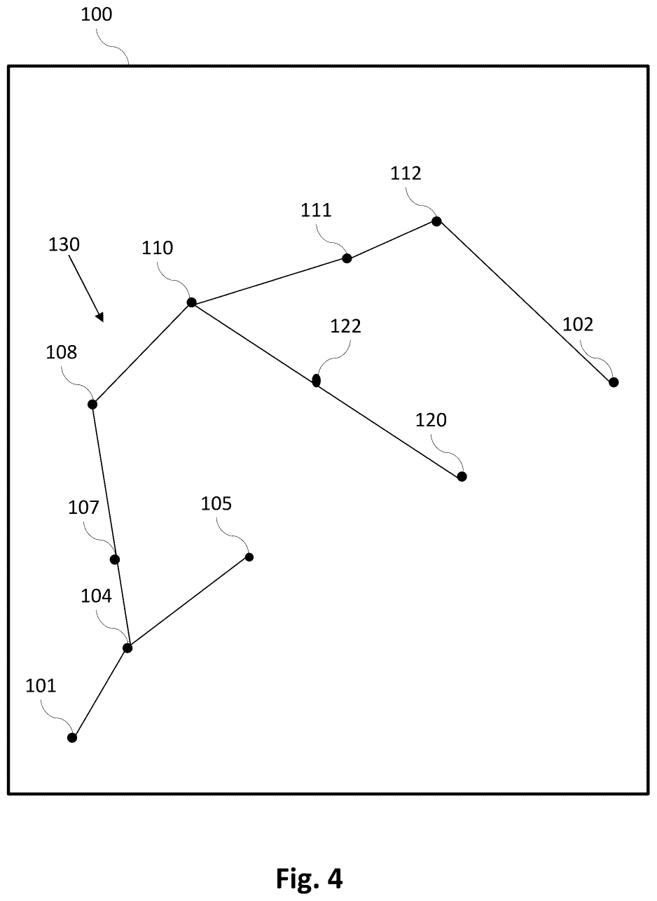

Referring to FIG. 4, in the RRT algorithm, when defining a random point 120, comparing the distance between a tree node 110 and the random point 120. When the distance is above a threshold, the random point 120 is disregarded and a new random point 122 is defined. The distance between the tree node 110 and the new random point 122 is equal to a threshold, and the new random point 122 is located on a straight line having the same direction as the straight line between the tree node 110 and the random point 120. That is, the direction from the tree node 110 to the new random point 122 is the same as the direction from the tree node 110 to the disregarded random point 120.

By this method, when defining the random nodes in the RRT algorithm, the random nodes should not be too far away from the tree nodes. Hence the efficiency of the RRT algorithm is improved.

According to another embodiment, the method further comprises: l. defining a current point 108 in the optimized path 230, the current point 108 being different from the first point and the end point; m. defining a random direction and a random distance; n. moving the current point 108 in the random direction for the random distance to obtain an updated current point 108′ in an updated optimized path, if the total length of the updated optimized path is shorter than the optimized path 230, and straight lines 201′, 202′ can be drawn between the updated current point 108′ and its preceding and following point 101, 110 in the optimized path 230.

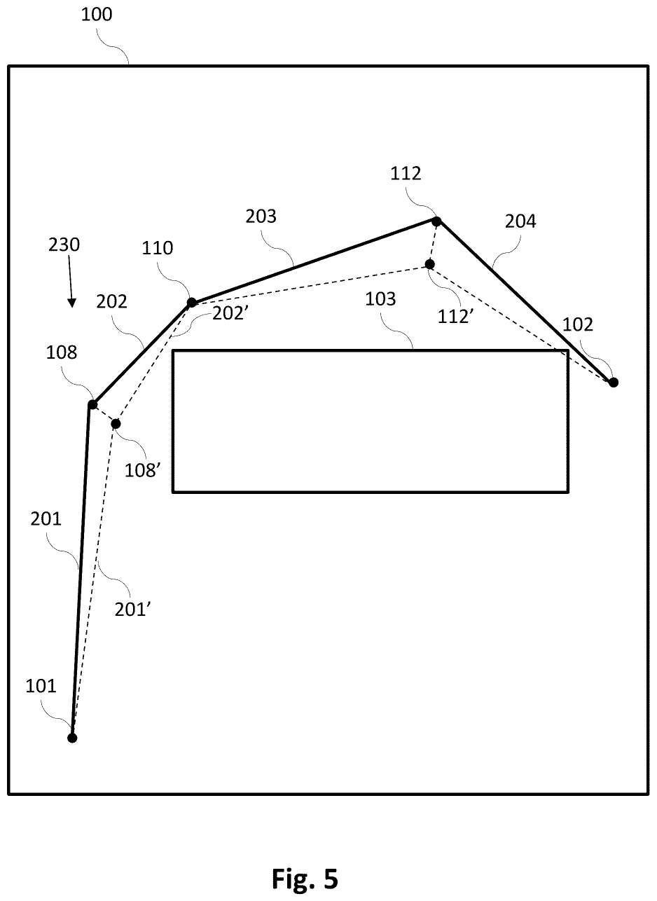

This embodiment is a method which is used to further optimize the optimized path 230. Referring to FIG. 5, after an optimized path 230 is generated, in the step l, a current point is defined. The current point should be an intermediate point in the optimized path 230 between the first point 101 and the end point 102. In the example, 108 is defined as the current point.

In the step m, a random direction and a random distance is defined. In the step n, an updated current point 108′ is determined by moving the current random point 108 for the random distance in the random direction. Meanwhile, the updated optimized path 201′, 202′, 203, 204 should be shorter than the optimized path 230, i.e., 201, 202, 203, 204, and the lines 201′ and 202′ should not go through the obstacle 103. In this situation, the updated current point 108′ is actually determined and the optimized path is updated.

In another example, for a current point 112, if it is moved to point 112′, a straight line cannot be drawn between the point 112′ and its following point 102, therefore the point 112′ cannot be determined as an updated current point, and the optimized path 230 is not updated on the point 112.

By this method, the optimized path 230 is further optimized and updated so that the updated optimized path becomes shorter than before.

According to another embodiment, the method further comprising: o. defining a current point 108 in the optimized path 230, the current point 108 being different from the first point and the end point; p. defining a forward offset point 108″ of the current point 108 by moving the current point 108 a predetermined distance towards the preceding point in the optimized path 230; q. defining a backward offset point 108′″ of the current point 108 by moving the current point 108 the predetermined distance towards the following point in the optimized path 230; r. if a straight line 206 can be drawn between the forward offset point 108″ and the backward offset point 108′″, increasing the predetermined distance and go to the step p; s. if a straight line cannot be drawn between the forward offset point 108″ and the backward offset point 108′″, replacing the current point 108 with previous forward offset point 108″ and previous backward offset point 108′″ in the optimized path 230.

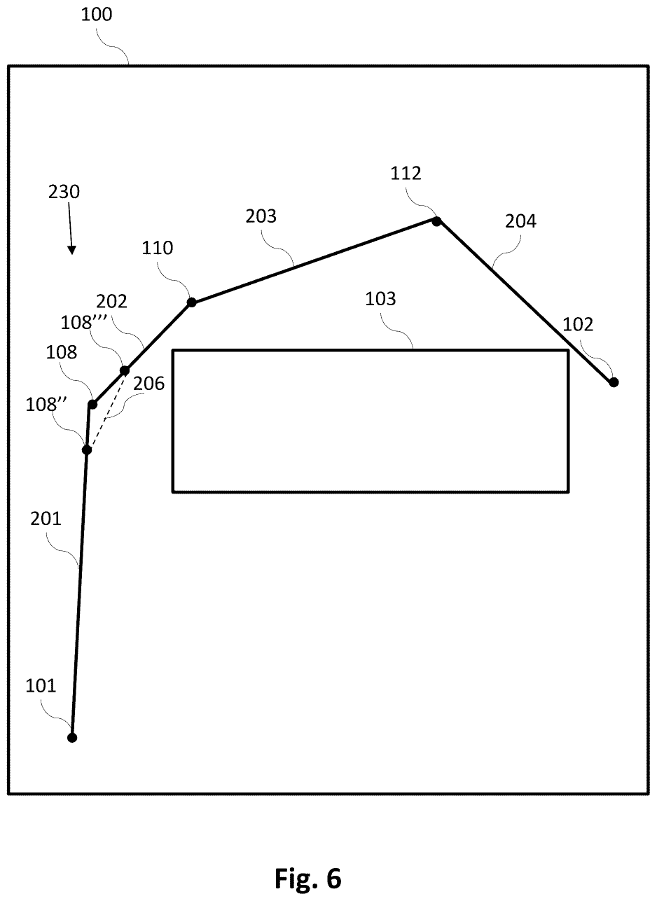

This embodiment is another method for further optimizing the optimized path 230. In this embodiment, referring to FIG. 6, after the optimized path 230 is generated, a current point 108 is defined in the step o. In the step p, a forward offset point 108″ is defined by moving the current point 108 forward towards the preceding point 101. The moving distance is predefined.

In the step q, a backward offset point 108′″ is defined by moving the current point 108 backward towards the following point 110. The moving distance is predefined and the same as the distance between the current point 108 and the forward offset point 108″.

In the step r, if it is determined that a straight line 206 can be drawn between the forward offset point 108″ and the backward offset point 108′″, it indicates that there is still room for a smoother path, so that the predetermined distance can be increased. The forward offset point 108″ is moved nearer to the preceding point 101 and the backward offset point 108′″ is moved nearer to the following point 110 in the step p.

In the step s, if it is determined that a straight line 206 cannot be drawn between the forward offset point 108″ and the backward offset point 108′″, i.e., blocked by the obstacle 103, the previous forward offset point 108″ and backward offset point 108′″ replace the current point 108 and the updated optimized path comprises points 101, 108″, 108′″, 110, 112, 102.

By this method, the optimized path 230 is further updated and becomes shorter and smoother. AN angle in the optimized path 230 is replace by a line 206.

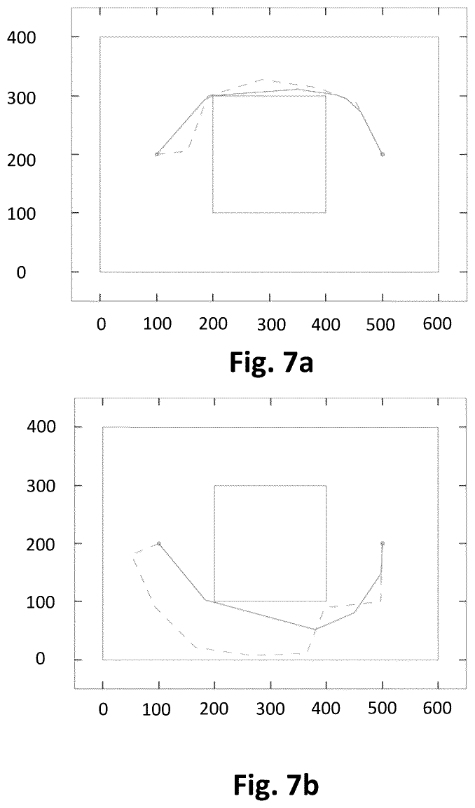

Referring to the FIGS. 7a and 7b, dotted lines are an original path generated by RRT algorithm, and solid lines are an optimized path generated by one or more of the methods described above. It is clearly shown that the optimized path is shorter and smoother than the original path in each figure.

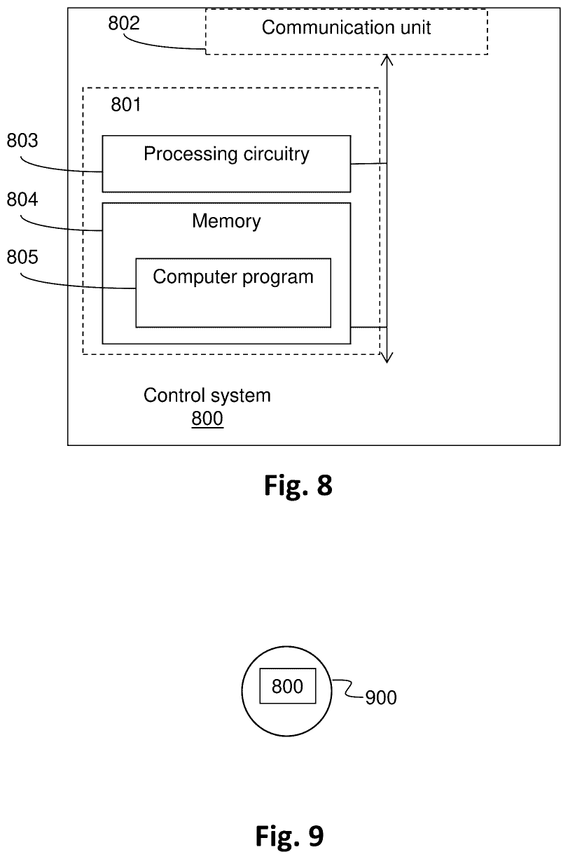

According to another embodiment, referring to FIG. 8, a control system 800 is disclosed. The control system 800 is used for generating an optimized path 230 between a starting point 101 and a target point 102 in a predefined area 100. The predefined area 100 comprises at least one obstacle 103 blocking a straight path between the starting point 101 and the target point 102. The control system 800 is operative for performing a method comprising a tree generating phase using a Rapidly-exploring Random Tree, RRT, algorithm, resulting in a tree 130 comprising the starting point 101, the target point 102 and at least one random point 104, 105, 106, 107, 108, 109, 110, 111, 112 there in between. The control system 800 comprises a processing circuitry 803 and a memory 804, the memory 804 containing instructions executable by the processing circuitry 803. The control system 800 is further operative for performing the method comprising a tree optimizing phase following the tree generating phase, the tree optimizing phase comprises: a. obtaining an original path 240 from the generated tree 130, wherein the original path 240 is the shortest path in the tree 130 from the starting point 101 to the target point 102 and with intermediate points 104, 107, 108, 110, 111, 112 there in between; b. defining a first point and an end point of the original path 240, wherein the first point is the starting point 101 and the end point is the target point 102 or the first point is the target point 102 and the end point is the starting point 101; c. determining the first point of the original path 240 as a first optimized point of the optimized path 230 and defining an optimizing direction starting from the first optimized point to the end point; d. defining the first optimized point as a current point in the optimized path 230; e. using the next intermediate point 104, 107, 108, 110, 111, 112 in the optimizing direction of the original path 240, starting from the current point, as a test point; f. determining if a straight line can be drawn between the current point and the test point; and g. if it is determined in the step f that a straight line can be drawn between the current point and the test point, using the next intermediate point 104, 107, 108, 110, 111, 112 from the test point in the optimizing direction of the original path 240 as an updated test point and return to step f; or h. if it is determined in the step g that a straight line cannot be drawn between the current point and test point, adding the previous test point, as an optimized point, to the optimized path 230, and defining the previous test point as the current point; i. determining if a straight line can be drawn between the added optimized point and the end point; j. if it is determined in the step i that a straight line can be drawn between the added optimized point and the end point, adding the end point to the optimized path 230, the method is finished and the optimized path 230 is generated; k. if it is determined in the step i that a straight line cannot be drawn between the added optimized point and the end point, return to step e.

According to other embodiments, the control system 800 is further operative for performing the methods defined in above embodiments.

According to another embodiment, the control system 800 can be arranged in a lawn mower or in a network device. The network device can be any kind of device which is connected to a network and capable of arranging the control system 800.

According to another embodiment, referring to FIG. 9, a lawn mower 900 comprising the control system 800 is disclosed. The lawn mower 900 is operative for moving along the optimized path 230 generated by the control system 800.

By this embodiment, the lawn mower 900 can move through the optimized path 230 so as to reach its destination more efficiently without meeting any obstacle.

According to another embodiment, the lawn mower 900 is operative for moving along a curve when turning.

By this embodiment, the lawn mower 900 avoids sharp turning when moving.

According to other embodiments, referring to FIG. 8, the control system 800 may further comprise a communication unit 802, which may be considered to comprise conventional means for wireless communication with other devices, such as a transceiver for wireless transmission and reception of signals. The instructions executable by said processing circuitry 803 may be arranged as a computer program 805 stored e.g. in said memory 804. The processing circuitry 803 and the memory 804 may be arranged in a sub-arrangement 801. The sub-arrangement 801 may be a micro-processor and adequate software and storage therefore, a Programmable Logic Device, PLD, or other electronic component(s)/processing circuit(s) configured to perform the methods mentioned above. The processing circuitry 803 may comprise one or more programmable processor, application-specific integrated circuits, field programmable gate arrays or combinations of these adapted to execute instructions.

The computer program 805 may be arranged such that when its instructions are run in the processing circuitry, they cause the control system 800 to perform the steps described in any of the described embodiments of the control system 800 and its method. The computer program 805 may be carried by a computer program product connectable to the processing circuitry 803. The computer program product may be the memory 804, or at least arranged in the memory. The memory 804 may be realized as for example a RAM (Random-access memory), ROM (Read-Only Memory) or an EEPROM (Electrical Erasable Programmable ROM). In some embodiments, a carrier may contain the computer program 805. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 804. Alternatively, the computer program may be stored on a server or any other entity to which the control system 800 has access via the communication unit 802. The computer program 805 may then be downloaded from the server into the memory 804.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a control system (800) for generating an optimized path (230) between a starting point (101) and a target point (102) in a predefined area (100), the predefined area (100) comprises at least one obstacle (103) blocking a straight path between the starting point (101) and the target point (102), the method comprises a tree generating phase using a Rapidly-exploring Random Tree, RRT, algorithm, resulting in a tree (130) comprising the starting point (101), the target point (102) and at least one random point (104, 105, 106, 107, 108, 109, 110, 111, 112) there in between, wherein the method further comprises a tree optimizing phase comprising:
a) obtaining an original path (240) from the generated tree (130), wherein the original path (240) is the shortest path in the tree (130) from the starting point (101) to the target point (102) and with intermediate points (104, 107, 108, 110, 111, 112) there in between;
b) defining a first point and an end point of the original path (240), wherein the first point is the starting point (101) and the end point is the target point (102) or the first point is the target point (102) and the end point is the starting point (101);
c) determining the first point of the original path (240) as a first optimized point of the optimized path (230) and defining an optimizing direction starting from the first optimized point to the end point;
d) defining the first optimized point as a current point in the optimized path (230);
e) using the next intermediate point (104, 107, 108, 110, 111, 112) in the optimizing direction of the original path (240), starting from the current point, as a test point;
f) determining if a straight line can be drawn between the current point and the test point; and
g) if it is determined in the step f that a straight line can be drawn between the current point and the test point, using the next intermediate point (104, 107, 108, 110, 111, 112) from the test point in the optimizing direction of the original path (240) as an updated test point and return to step f; or
h) if it is determined in the step f that a straight line cannot be drawn between the current point and test point, adding the previous test point, as an optimized point, to the optimized path (230), and defining the previous test point as the current point;
i) determining if a straight line can be drawn between the added optimized point and the end point;
j) if it is determined in the step i that a straight line can be drawn between the added optimized point and the end point, adding the end point to the optimized path (230), the method is finished and the optimized path (230) is generated;
k) if it is determined in the step i that a straight line cannot be drawn between the added optimized point and the end point, return to step e.

2. The method as claimed in claim 1, wherein the RRT-algorithm uses a max extension policy, i.e., setting a predetermined threshold for the maximum distance between a tree node (110) and a random point (120) in the generated tree (130); if the distance between the tree node (110) and the random point (120) is greater than this predetermined threshold, disregarding the random point (120) and defining a new random point (122), wherein the distance from the tree node (110) to the new random point (122) is the predetermined threshold and the new random point (122) is located on a straight line having the same direction as the straight line between the tree node (110) and the disregarded random point (120).

3. The method as claimed in claim 1, the method further comprising:
l) defining a current point (108) in the optimized path (230), the current point (108) being different from the first point and the end point;
m) defining a random direction and a random distance;
n) moving the current point (108) in the random direction for the random distance to obtain an updated current point (108′) in an updated optimized path, if the total length of the updated optimized path is shorter than the optimized path (230), and straight lines (201′, 202′) can be drawn between the updated current point (108′) and its preceding and following point (101, 110) in the optimized path (230).

4. The method as claimed in claim 1, the method further comprising:
o) defining a current point (108) in the optimized path (230), the current point (108) being different from the first point and the end point;
p) defining a forward offset point (108″) of the current point (108) by moving the current point (108) a predetermined distance towards the preceding point in the optimized path (230);
q) defining a backward offset point (108′″) of the current point (108) by moving the current point (108) the predetermined distance towards the following point in the optimized path (230);
r) if a straight line (206) can be drawn between the forward offset point (108″) and the backward offset point (108′″), increasing the predetermined distance and go to the step p;
s) if a straight line cannot be drawn between the forward offset point (108″) and the backward offset point (108′″), replacing the current point (108) with previous forward offset point (108″) and previous backward offset point (108′″) in the optimized path (230).

5. A control system (800) for generating an optimized path (230) between a starting point (101) and a target point (102) in a predefined area (100), the predefined area (100) comprises at least one obstacle (103) blocking a straight path between the starting point (101) and the target point (102), the control system (800) is operative for performing a method comprising a tree generating phase using a Rapidly-exploring Random Tree, RRT, algorithm, resulting in a tree (130) comprising the starting point (101), the target point (102) and at least one random point (104, 105, 106, 107, 108, 109, 110, 111, 112) there in between, the control system (800) comprises a processing circuitry (803) and a memory (804), the memory (804) containing instructions executable by the processing circuitry (803), whereby the control system (800) is further operative for performing the method comprising a tree optimizing phase following the tree generating phase, the tree optimizing phase comprises:
a) obtaining an original path (240) from the generated tree (130), wherein the original path (240) is the shortest path in the tree (130) from the starting point (101) to the target point (102) and with intermediate points (104, 107, 108, 110, 111, 112) there in between;
b) defining a first point and an end point of the original path (240), wherein the first point is the starting point (101) and the end point is the target point (102) or the first point is the target point (102) and the end point is the starting point (101);
c) determining the first point of the original path (240) as a first optimized point of the optimized path (230) and defining an optimizing direction starting from the first optimized point to the end point;
d) defining the first optimized point as a current point in the optimized path (230);
e) using the next intermediate point (104, 107, 108, 110, 111, 112) in the optimizing direction of the original path (240), starting from the current point, as a test point;
f) determining if a straight line can be drawn between the current point and the test point; and
g) if it is determined in the step f that a straight line can be drawn between the current point and the test point, using the next intermediate point (104, 107, 108, 110, 111, 112) from the test point in the optimizing direction of the original path (240) as an updated test point and return to step f; or
h) if it is determined in the step f that a straight line cannot be drawn between the current point and test point, adding the previous test point, as an optimized point, to the optimized path (230), and defining the previous test point as the current point;
i) determining if a straight line can be drawn between the added optimized point and the end point;
j) if it is determined in the step i that a straight line can be drawn between the added optimized point and the end point, adding the end point to the optimized path (230), the method is finished and the optimized path (230) is generated;
k) if it is determined in the step i that a straight line cannot be drawn between the added optimized point and the end point, return to step e.

6. A control system (800) for generating an optimized path (230) between a starting point (101) and a target point (102) in a predefined area (100), the predefined area (100) comprises at least one obstacle (103) blocking a straight path between the starting point (101) and the target point (102), the control system (800) is operative for performing a method comprising a tree generating phase using a Rapidly-exploring Random Tree, RRT, algorithm, resulting in a tree (130) comprising the starting point (101), the target point (102) and at least one random point (104, 105, 106, 107, 108, 109, 110, 111, 112) there in between, the control system (800) comprises a processing circuitry (803) and a memory (804), the memory (804) containing instructions executable by the processing circuitry (803), whereby the control system (800) is further operative for performing the method comprising a tree optimizing phase following the tree generating phase, the tree optimizing phase comprises:
a) obtaining an original path (240) from the generated tree (130), wherein the original path (240) is the shortest path in the tree (130) from the starting point (101) to the target point (102) and with intermediate points (104, 107, 108, 110, 111, 112) there in between;
b) defining a first point and an end point of the original path (240), wherein the first point is the starting point (101) and the end point is the target point (102) or the first point is the target point (102) and the end point is the starting point (101);
c) determining the first point of the original path (240) as a first optimized point of the optimized path (230) and defining an optimizing direction starting from the first optimized point to the end point;
d) defining the first optimized point as a current point in the optimized path (230);
e) using the next intermediate point (104, 107, 108, 110, 111, 112) in the optimizing direction of the original path (240), starting from the current point, as a test point;
f) determining if a straight line can be drawn between the current point and the test point; and
g) if it is determined in the step f that a straight line can be drawn between the current point and the test point, using the next intermediate point (104, 107, 108, 110, 111, 112) from the test point in the optimizing direction of the original path (240) as an updated test point and return to step f; or
h) if it is determined in the step f that a straight line cannot be drawn between the current point and test point, adding the previous test point, as an optimized point, to the optimized path (230), and defining the previous test point as the current point;
i) determining if a straight line can be drawn between the added optimized point and the end point;
j) if it is determined in the step i that a straight line can be drawn between the added optimized point and the end point, adding the end point to the optimized path (230), the method is finished and the optimized path (230) is generated;
k) if it is determined in the step i that a straight line cannot be drawn between the added optimized point and the end point, return to step e, the control system (800) is further operative for performing the methods defined in claim 2.

7. A lawn mower (900) comprising the control system (800) claimed in claim 5, wherein the lawn mower (900) is operative for moving along the optimized path (230) generated by the control system (800).

8. The lawn mower (900) as claimed in claim 7, the lawn mower (900) is operative for moving along a curve when turning.

9. A computer program (805) comprising instructions, which, when executed by a processing circuitry (803) of a control system (800), causes the control system (800) to generate an optimized path (230), according to the method as claimed in claim 1.

10. A carrier containing the computer program (805) according to claim 9, wherein the carrier is one of an electronic signal, an optical signal, a radio signal, an electric signal, or a computer readable storage medium.
